(19) United States
(12) Patent Application Publication
(10) Pub. No.: US 2021/0184277 A1
(43) Pub. Date: Jun. 17, 2021

(54) BATTERY PACK SYSTEM WITH INTEGRATED CHARGING DEVICE

(71) Applicant: Daniel Polchinski, Orlando, FL (US)

(72) Inventor: Daniel Polchinski, Orlando, FL (US)

(21) Appl. No.: 17/103,566

(22) Filed: Nov. 24, 2020

Related U.S. Application Data
(60) Provisional application No. 62/946,818, filed on Dec. 11, 2019.

(51) Int. Cl. H01M 10/46; H02J 7/04; H02J 7/00; H01M 50/204; H01M 50/247; H01M 50/296; H01M 10/42

(52) U.S. Cl. CPC H01M 10/46; H02J 7/04; H02J 7/0042; H01M 50/204; H01M 2010/4271; H01M 50/296; H01M 10/425; H01M 2220/30; H01M 50/247

(57) ABSTRACT

A battery pack system includes a main body having a tool attachment mechanism and a set of terminals along the outside surface. The tool attachment mechanism including a shape and a size that is designed to engage the battery receptacle of a commercially available power tool. A battery pack is positioned inside the main body and is in electrical communication with the terminals. A controller and onboard battery charger are positioned within the main body and are in communication with the battery pack and the set of terminals. A receptacle is positioned along the main body for receiving electricity from an electric cord. The battery charger and controller include functionality for charging the battery pack and for supplying power directly to the set of terminals when the electric cord is plugged into the electrical outlet.

### CROSS-REFERENCE TO RELATED APPLICATIONS

This application claims the benefit of U.S. Application Ser. No. 62/946,818 filed on Dec. 11, 2019, the contents of which are incorporated herein by reference.

### TECHNICAL FIELD

The present invention relates generally to the field of battery-operated components. and more particularly to a battery pack system having an integrated charging device.

### BACKGROUND

The statements in this section merely provide background information related to the present disclosure and may not constitute prior art.

In recent years, the use and popularity of battery-operated tools and garden components has skyrocketed. As such, many manufacturers offer a wide array of battery-operated “tools” which include various drills, power saws, sanders, edger's, leaf blowers and even lawn mowers, for example. This increase in popularity is attributed to improvements in battery designs and components which are lighter and more powerful than ever before.

Moreover, because the batteries are able to be used for multiple tools within the same manufacturer brand, many consumers purchase one, or perhaps two batteries and use them to operate any number of different power tools. Unfortunately, it is not uncommon for a battery to become depleted before a user is finished with a given task. In these situations, the user will typically swap the depleted battery with a freshly recharged battery to continue working. However, if the user does not have a replacement battery, or if the second battery is in use, the user currently has no choice but to stop working and wait for the charging process to complete. In some instances, this process can take more than an hour, thus costing the user much time and frustration.

Accordingly, it would be beneficial to provide a battery pack system having an integrated charging device that can allow a user to selectively connect the battery to a power outlet in order to continue using a connected power tool while recharging the battery, so as to overcome the drawbacks described above.

### SUMMARY OF THE INVENTION

The present invention is directed to a battery pack system for use with a power tool. One embodiment of the present invention can include a main body having a tool attachment mechanism and a set of terminals along the outside surface. A battery pack is positioned inside the main body and is in electrical communication with the terminals. The tool attachment mechanism can include a shape and a size that is designed to be used with a power tool having a battery receptacle with a known shape and size.

In one embodiment, a controller and onboard battery charger are positioned within the main body and are in communication with the battery pack and the set of terminals. A receptacle is positioned along the main body and is configured to engage an electric cord. The electric cord and receptacle can engage an AC electrical outlet to supply electricity to the onboard battery charger.

In one embodiment, the battery charger and controller can include functionality for charging the battery pack and for supplying power directly to the set of terminals when the electric cord is plugged into the electrical outlet.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a battery pack system with integrated charging device that is useful for understanding the inventive concepts disclosed herein.

FIG. 2 is a simplified block diagram of the electronic suite of the battery pack system with integrated charging device, in accordance with one embodiment of the invention.

FIG. 3 is a perspective view of the battery pack system with integrated charging device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the terms “connector” and “complementary connector” include any number of different elements that work together to repeatedly join two items together in a nonpermanent manner. Several nonlimiting examples include opposing strips of hook and loop material (i.e. Velcro®), attractively-oriented magnetic elements, flexible strips of interlocking projections with a slider (i.e., zipper), tethers, buckles such as side release buckles, and compression fittings such as T-handle rubber draw latches, hooks, snaps and buttons, for example. Each illustrated connector and complementary connector can be permanently secured to the illustrated portion of the device via a permanent sealer such as glue, adhesive tape, or stitching, for example.

As described herein, a “power tool” can include any type of device produced by any manufacturer that is capable of receiving power from a battery pack.

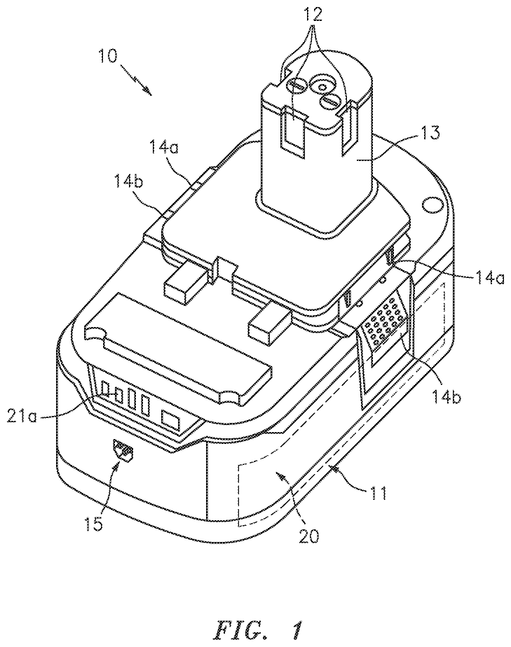

FIGS. 1-3 illustrate one embodiment of a battery system with integrated charging device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

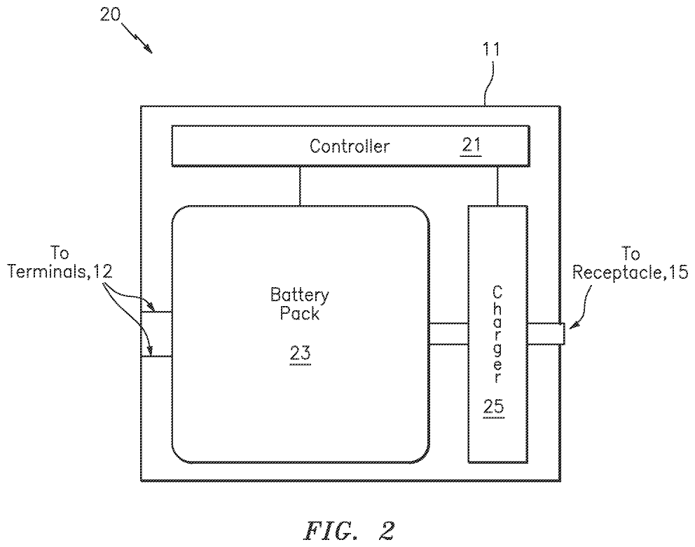

As shown at FIGS. 1 and 2, the inventive battery system 10 can include, essentially, a main body 11 having a set of terminals 12, and a power cord receptacle 15, that are connected to an electronic suite 20 positioned within the main body.

As described herein, the main body 11 can include any number of different shapes and sizes and can be constructed from any number of electrically non-conductive materials suitable for housing each of the electronic elements. In one preferred embodiment, the main body 11 can be constructed from rugged plastic, having a plurality of internal connectors (not shown) for securely housing the internal battery components. Of course, any number of other known construction materials such as PVC and composites, for example, are also contemplated.

The terminals 12 can be communicatively linked to the below described electronic suite 20 and can include any number of different shapes and sizes. The terminals can be constructed from an electrically conductive metal, and can function to supply electricity from the battery to a power tool to which the system 10 is connected.

In one embodiment, the main body 11 can include a power tool attachment mechanism 13 that functions to align and position the system terminals 12 against a set of electrical contacts on a power tool. As previously noted, power tool manufacturers utilize a specific shape and sized battery receptacle for each family of power tools. As such, the attachment mechanism can include any number of different shapes and sizes, suitable for engaging any number of different power tools.

In one embodiment, the power tool engagement mechanism can include a slide-on tongue design or the illustrated post-style mechanism 13 having a connector such as the illustrated retractable catch lever 14a and release button(s) 14b. The engagement mechanism functioning to engage a complementary shaped and sized battery receptacle, and the connector functioning to engage complementary connectors/securement component(s) found on any number of commercially available power tools from manufacturers such as Ryobi®, Black and Decker®, and DeWALT®, for example. Of course, any number of other shapes, sizes types of connectors and/or manufacturers are also contemplated.

The power cord receptacle 15 can be positioned anywhere along the main body 11 and can function to receive electrical power from an outside source. In the illustrated embodiment, the receptacle 15 can include 3 prongs that are arranged to engage a 120v AC power cord 15a that is plugged into an AC electrical outlet.

Of course, the receptacle 15 is not limited to any number of prongs and/or AC power, as other embodiments are contemplated wherein the receptacle includes a different orientation of prongs, a different number of prongs, is configured to receive a different voltage (e.g., 240v) and/or is configured to receive DC power from a power cable. Likewise, the cord need not be removable, as the same can be permanently installed onto the receptacle 15 and maintained by a cord management system.

FIG. 2 illustrates one embodiment of the electronic suite 20 of the system 10. As shown, the suite can include a controller 21, that is connected to a battery pack 23 and a battery charger 25.

The controller 21 can include, comprise or consist of one or more printed circuit boards (PCB) containing any number of integrated circuit or circuits to complete the activities described herein. To this end, the controller can include one or more processors that are conventionally connected to one or more memory components for storing operating and communication instructions.

In one embodiment, the controller can include one or more temperature sensing circuits for ceasing an operation of the charger or output of the power cells in the event that the temperature exceeds a predetermined threshold. Likewise, the controller can include one or more input/output units for communicating information with a user. In the preferred embodiment, the input/output unit can include a device status indication such as the LED's 21a, for example, to provide a user with a visual indication of the power level of the batteries and/or an operational state of the charger.

Of course, any number of other analog and/or digital components capable of performing the functionality described herein can be provided in place of, or in conjunction with the above described controller elements.

In operation, the controller 21 includes functionality for permitting the device 10 to: 1) supply power to a connected power tool, 2) communicate with and selectively receive power from an external battery charger via the terminals 12 in the known and conventional manner, 3) regulate the operation of the onboard charger 25 to charge the onboard battery pack 23 and 4) regulate the operation of the onboard charger to supply output power to a connected power tool via the terminals 12.

The battery pack 23 can include any number of individual rechargeable power cells which may be arranged serially and/or in parallel to produce any desired voltage such as 12v, 18v, 20v and/or 40v, for example. In the preferred embodiment, the cells will comprise lightweight lithium-ion polymer (LiPo) batteries; however any number of other battery types are also contemplated, several nonlimiting examples include nickel-cadmium (NiCd), nickel-metal hydride (NiMH), lithium-ion (Li-ion), and rechargeable alkaline batteries, for example.

The charger 25 can be communicatively linked to the power receptacle 15 and can include an internally located transformer and other circuitry that function to convert the received power into a useable electrical charge for the battery pack 23. To this end, the type of charger and the output voltage will be dependent on the type of cells used and the output voltage of the battery pack 23. For example, if the above described LiPo batteries are utilized within the battery pack, the charger 25 would comprise a Lithium-Ion battery charger having built-in cell balancer.

In the preferred embodiment, the charger 25 will include functionality for communicating with the output terminals 12 in order to selectively provide operating power to the terminals either directly or via the battery pack 23.

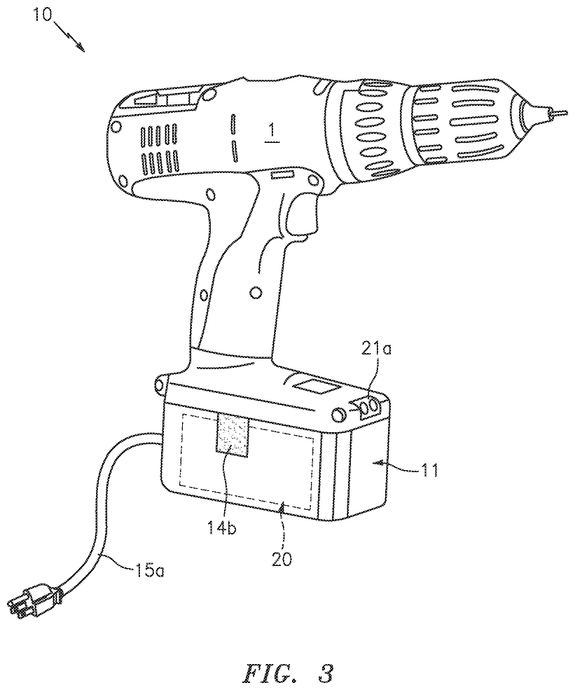

As shown at FIG. 3, such a feature allows the battery pack system 10 to operate a power tool 1 to which it is attached by using the onboard battery pack 23, and/or by converting the electrical input received by the power cord 15a for direct use by the tool.

Although not specifically illustrated, the battery pack system 10 can include any number of components such as diodes and the like for preventing drainage or discharge of the battery pack 23. Likewise, the controller can include functionality for preventing overcharge of the batteries via the onboard charger 25 and an external battery charger.

As described herein, one or more elements of the battery pack system 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A battery pack system, comprising:
a main body having an outside surface and an interior space;
a battery pack that is positioned within the interior space;
a set of terminals that are in communication with the battery pack, and are positioned along the outside surface of the main body; and
a battery charger that is in communication with the battery pack,
wherein the battery charger is positioned within the interior space of the main body.

2. The system of claim 1, further comprising:
a controller that is positioned within the main body, said controller being in communication with each of the battery charger and the battery pack.

3. The system of claim 2, wherein the battery pack and the controller include functionality for supplying power from the battery pack to a power tool that is connected to the set of terminals.

4. The system of claim 2, wherein the battery pack and the controller include functionality for receiving power to the battery pack from an external battery charger that is connected to the set of terminals.

5. The system of claim 2, wherein the controller includes functionality for regulating an operation of the battery charger.

6. The system of claim 1, further comprising:
a power receptacle that is positioned along the main body, said power receptacle being in communication with the battery charger.

7. The system of claim 6, wherein the power receptacle and the battery charger are configured to receive AC electricity.

8. The system of claim 6, further comprising a power cord that is configured to removably engage the power receptacle and an AC electrical outlet.

9. The system of claim 1, wherein the battery pack includes a plurality of individual cells having an output voltage of 6v, 12v, 18v or 40v.

10. The system of claim 9, wherein each of the plurality of individual cells comprise one of a lithium-ion polymer battery, a nickel-cadmium battery, a nickel-metal hydride battery, or a rechargeable alkaline battery.

11. The system of claim 10, wherein the battery charger comprises at least one of a
a lithium-ion polymer battery charger, a nickel-cadmium battery charger, a nickel-metal hydride battery charger, or a rechargeable alkaline battery charger.

12. The system of claim 1, further comprising:
a power tool engagement mechanism having a shape and size that is complementary to a shape and a size of a battery receptacle on a power tool.

13. The system of claim 12, wherein the set of terminals are located on the power tool engagement mechanism and are configured to engage complementary located terminals on the power tool.

14. The system of claim 1, further comprising:
a connector for removably securing the main body onto a power tool.

15. The system of claim 14, wherein the connector includes a catch lever that is positioned along the main body.

16. The system of claim 15, further comprising:
a release button that is mechanically coupled to the catch lever.
